(19) United States
(12) Patent Application Publication
(10) Pub. No.: US 2021/0120080 A1
(43) Pub. Date: Apr. 22, 2021

(54) LOAD BALANCING FOR THIRD PARTY SERVICES

(71) Applicant: VMWARE, INC., Palo Alto, CA (US)

(72) Inventors: RAHUL MISHRA, Palo Alto, CA (US); Kantesh Mundaragi, Pune (IN); Raju Koganty, Palo Alto, CA (US)

(21) Appl. No.: 16/785,674

(22) Filed: Feb. 10, 2020

(30) Foreign Application Priority Data
Oct. 16, 2019 (IN) 201941041904

(51) Int. Cl. H04L 29/08; H04L 12/24; H04L 12/66

(52) U.S. Cl. CPC H04L 67/1029; H04L 41/0893; H04L 67/327; H04L 12/66; H04L 67/322; H04L 67/1036

(57) ABSTRACT

Some embodiments provide a novel method for distributing data message flows among multiple service nodes that provide a particular service in a managed network. In some embodiments, the service nodes provide an edge service at an edge device (e.g., a gateway) of the managed network. The method collects a set of attributes from each service node of the multiple service nodes regarding the service node from which the set of attributes are collected. The collected attributes may include usage statistics, characteristics of the service nodes, and characteristics of the connections to the service nodes. The collected attributes are used to compute a score (e.g., a weight or priority) for each service node. Based on the policy and the computed scores, a set of rules and tables are generated to distribute the data message flows to the service nodes to implement the policy.

### RELATED APPLICATIONS

Benefit is claimed under 35 U.S.C. 119(a)-(d) to Foreign Application Serial No. 201941041904 filed in India entitled “LOAD BALANCING FOR THIRD PARTY SERVICES” on Oct. 16, 2019, by VMWARE, Inc., which is herein incorporated in its entirety by reference for all purposes.

### BACKGROUND

An edge device in some datacenters interacts with third party services to provide a set of edge services for data message flows. In current systems, all data message flows requiring a particular service are processed by a particular service node which can become a bottleneck for north-south traffic. Additionally, it is difficult to meet different quality of service requirements for different flows that are all processed by a same service node. Accordingly, a method for avoiding the bottleneck of a single service node while meeting different quality of service requirements is necessary.

### BRIEF SUMMARY

Some embodiments provide a novel method for distributing data message flows among multiple service nodes that provide a particular service in a managed network. The service nodes, in some embodiments, are third party service nodes that are not directly managed as part of the managed network. In some embodiments, the service nodes provide an edge service at an edge device (e.g., a gateway) of the managed network. In some embodiments, the distribution is performed at a network edge device. The method collects a set of attributes from each service node of the multiple service nodes regarding the service node from which the set of attributes are collected. The collected attributes may include usage statistics, characteristics of the service nodes, and characteristics of the connections to the service nodes. The collected attributes, in some embodiments, are used to compute a score (e.g., a weight or priority) for each service node. The computed scores for the multiple service nodes and, in some embodiments, priorities associated with data message flows are used to distribute the data message flows to the service nodes.

In some embodiments, the service nodes are layer 2 bump-in-the-wire service nodes (i.e., service nodes that do not change the layer 2 addresses of a processed data message) inserted in an edge processing pipeline. In other embodiments, the service nodes are layer 3 service nodes or a combination of layer 2 and layer 3 service nodes. The service nodes may be software service nodes executing on a same host computer as a gateway for the managed network or hardware or software service nodes provided by a third-party device. A network control system (e.g., a network controller and/or network manager, or cluster of network controllers and/or managers), in some embodiments, communicates with the service nodes to collect the set of attributes from each service node.

Some embodiments receive policies (e.g., as user input) specifying sets of criteria (n-tuples, IP addresses, ports, etc.) that define data message flows along with a service to provide for data message flows meeting certain criteria in the sets of criteria. A policy may additionally specify a priority (e.g., a quality of service) for the data message flows meeting certain criteria in the sets of criteria. Based on the policy (e.g., user input) and the computed scores, a set of rules are generated to implement the policy. In some embodiments, the rules include policy-based routing rules that are defined in terms of a source and destination IP addresses and ports and specify a universally unique identifier (UUID) for a service node (or service node group). Some embodiments also configure a policy table that uses the UUID to identify a next hop for a data message. In embodiments in which the rule identifies a group of service nodes, an additional table is configured (1) to select one service node in the group of service nodes associated with the group UUID and (2) to determine the UUID of the selected service node to use to identify the next hop for the data message.

Service nodes, in some embodiments, are configured in high-availability clusters having one active service node and a set of standby service nodes to perform the service if the active service fails or is shut down. Details about the use of service nodes in high availability clusters can be found in U.S. patent application Ser. No. 15/937,615, now published as U.S. Patent Publication 2019/0306086 which is hereby incorporated by reference. A high-availability cluster of service nodes, in some embodiments, is identified by a same UUID. In embodiments with multiple high-availability clusters, upon failure of one high-availability cluster another high-availability (HA) cluster can begin processing data flows processed by the failed cluster.

For a data message received at an edge node performing an embodiment of the invention, some embodiments first consult a cache to see if a service node has already been identified to provide the service for the data message flow to which the data message belongs. If no service node has been identified, the rules and tables discussed above are used to identify a service node (or HA cluster) to provide the service for the data message flow and the identified service node is associated with the data message flow in the cache to ensure that the same service node processes all data messages of the data message flow.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and the Drawings.

### BRIEF DESCRIPTION OF THE DRAWINGS

The novel features of the invention are set forth in the appended claims.

However, for purposes of explanation, several embodiments of the invention are set forth in the following figures.

FIG. 1 illustrates an exemplary environment in which the invention is implemented.

FIG. 2 conceptually illustrates a process performed to collect attribute data sets from the service nodes and to compute scores for different service nodes for which data is collected.

FIG. 3 conceptually illustrates a process for generating rules and tables based on a policy identifying data message flows and services that the data message flows should receive.

FIG. 4 conceptually illustrates a process for processing data messages at a device configured with the rules and tables generated in the process described in relation to FIG. 3.

FIG. 5 illustrates a data message that hits a policy-based routing rule that identifies a single service node to provide the service required by the data message.

FIG. 6 illustrates a data message that hits a policy-based routing rule that identifies a UUID associated with a set of service nodes to provide the service required by the data message.

FIG. 7 illustrates a gateway device that has been configured to provide at least two services having its rules and tables updated based on new attribute data sets.

FIG. 8 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

As used in this document, data messages refer to a collection of bits in a particular format sent across a network. Also, as used in this document, a data flow refers to a set of data messages sharing a set of attributes (e.g. a five-tuple). One of ordinary skill in the art will recognize that the term data message may be used herein to refer to various formatted collections of bits that may be sent across a network, such as Ethernet frames, IP packets, TCP segments, UDP datagrams, etc. Also, as used in this document, references to L2, L3, L4, and L7 layers (or layer 2, layer 3, layer 4, layer 7) are references, respectively, to the second data link layer, the third network layer, the fourth transport layer, and the seventh application layer of the OSI (Open System Interconnection) layer model.

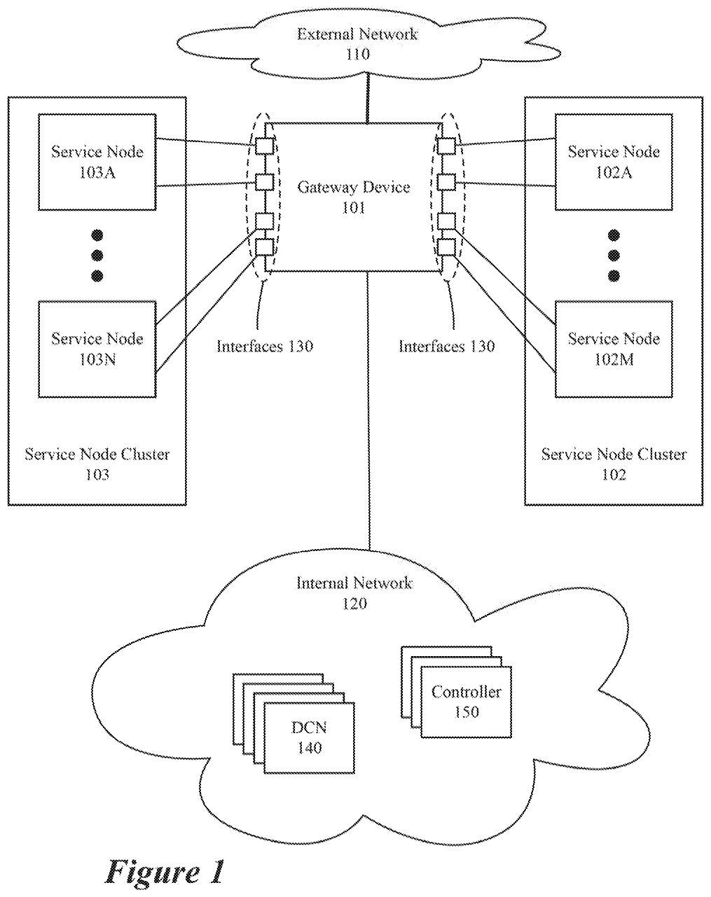

FIG. 1 illustrates an exemplary environment in which the invention is implemented. FIG. 1 includes a gateway device 101 sitting between an external network 110 and an internal network 120. Gateway device 101 connects to service node clusters 102 and 103 that, in the illustrated embodiments, provide different services. Each service node cluster 102 and 103 includes multiple service nodes (i.e., 102A-M and 103A-N) to provide the service to incoming or outgoing data messages. Each service node (i.e., 102A-M and 103A-N) is reached through a different set of interfaces 130. In some embodiments, at least one service node (e.g., 102A) is a high-availability cluster. Service node clusters 102 and 103, in some embodiments, are third party service nodes. Further details about the use of service nodes in high availability clusters can be found in U.S. patent application Ser. No. 15/937,615 which is hereby incorporated by reference.

FIG. 1 also illustrates that the internal network 120 includes a set of data compute nodes 140 (e.g., servers, virtual machines, containers, etc.) that are the destinations of data messages. The internal network 120 also includes a set of controllers 150 that implement a network control system (e.g., a network controller and/or network manager, or cluster of network controllers and/or managers) to manage elements of the internal network 120. The different elements of the internal network 120, in some embodiments, execute on a set of host computers (e.g., servers) as virtual machines, containers, namespaces, etc. that are managed by the network control system (e.g., set of controllers 150). The internal network 120, in some embodiments, also includes a set of managed forwarding elements and the internal network is managed to implement a set of logical networks (e.g., a set of logical forwarding elements and machines) that can belong to multiple tenants. Although they are illustrated as being separate from the internal network 120, one of ordinary skill in the art will understand that any or all of gateway device 101, service node cluster 102, and service node cluster 103 may be considered part of internal network 120 and may be executing on host computers in the internal network 120.

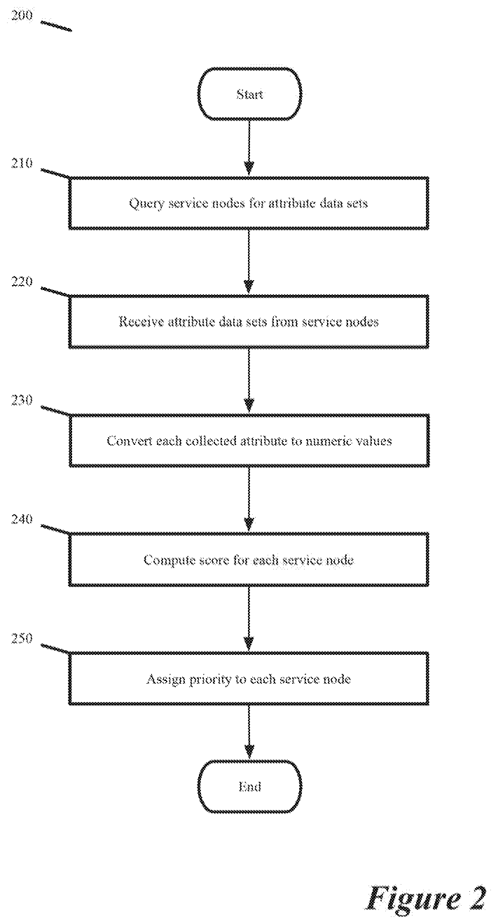

FIG. 2 conceptually illustrates a process 200 performed to collect attribute data sets from the service nodes and to compute scores for different service nodes for which data is collected. Process 200, in some embodiments, is performed by a network control system (e.g., a network controller and/or network manager, or cluster of network controllers and/or managers). In other embodiments, a module on the device (e.g., an edge device) that interacts with the service nodes performs the process 200. Process 200 begins by querying (at 210) the set of service nodes for attribute data sets. In some embodiments, the query is through an API provided by the service node. The collected attributes, in some embodiments, include any or all of usage statistics, characteristics of the service nodes, and characteristics of the connections to the service nodes.

Usage statistics include any or all of a current flow load (e.g., number of active flows currently handled by the service node), a number of dropped packets, a current CPU load (e.g., a percent of CPU processing power available), round trip time (e.g., determined by sending a dummy packet or by receiving information from service node regarding CPU and multithreading capacity), and additional usage statistics as relevant. Characteristics of the service nodes, and characteristics of the connections to the service nodes include any or all of CPU capacity, packet per second capacity, whether the service node is executing on a same host computer as the edge device, the bandwidth of the connection between the service node and the edge device. In some embodiments using HA clusters of service nodes, the attribute data set reflects only the attributes associated with the active service node.

The process 200 then receives (at 220) the attribute data sets for the service nodes. In some embodiments, operation 210 is omitted (or replaced by an indication that attribute data set reporting should be enabled for the service node) because the service nodes are configured (based on the indication) to periodically report the attribute data sets. The attribute data sets, in some embodiments, are received as a single set of attribute data from each service node, while in other embodiments, different attributes are collected from different sources (e.g., round trip time is collected by sending a dummy packet instead of querying the service node directly) or are received in different data sets.

The attributes in the received attribute data sets are converted (at 230) into values that can be used to compute scores for each service nodes. Converting (at 230) attributes into the values in some embodiments, includes converting different attributes that are non-numeric (e.g., location of service node) into numeric values and assigning weights to each attribute that reflect the relative importance of each attribute to the performance of a service node. For attributes (e.g., number of dropped data messages) that are negatively correlated with performance, an assigned weight is negative, in some embodiments, to reduce a computed score for larger values of the attribute. The converted weights are then used to compute (at 240) a score for each service node. In some embodiments, computing the score for a service node includes adding the values obtained by converting (at 230) the attributes to values using the assigned weights. Other methods of converting attributes into numeric values and computing scores for each service node will be understood by a person of ordinary skill in the art. In some embodiments not making use of priorities to assign data message flows to service nodes for processing, the process 200 ends here.

In other embodiments in which priorities are used to assign data message flows to service nodes for processing, the process continues to assign (at 250) a priority to each service node based on the computed scores. In some embodiments, the priorities correspond to a set of priorities that are specified (e.g., by a user) for data message flows when defining a quality of service for the data message flows. The priorities, in some embodiments, are assigned based on relative scores of service nodes providing a same service. In other embodiments, priorities are assigned based on score ranges associated with each priority. After assigning a priority to each service node, the process 200 ends. Process 200 is, in some embodiments, performed periodically to update the attribute data sets, the computed scores, and the assigned priorities for each service node. Process 200 is additionally, or alternatively, performed upon certain network events such as the addition of a new service node to a service node cluster, the removal of a service node from a service node cluster, and the failure of a service node in a high availability service node cluster. Further details about detecting the failure of service nodes in high availability clusters can be found in U.S. patent application Ser. No. 15/937,615 which is hereby incorporated by reference.

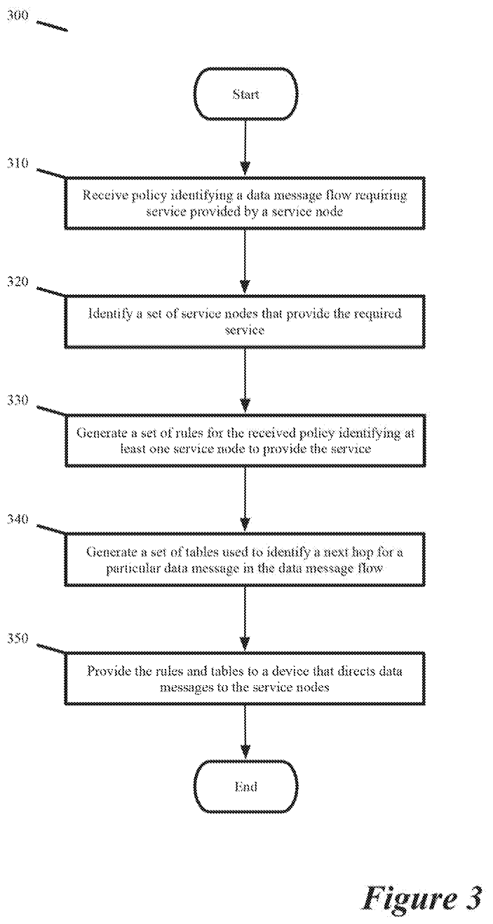

Once scores are computed and priorities are assigned, rules can be generated based on the scores and priorities to implement quality of service requirements, load balancing, or both. FIG. 3 conceptually illustrates a process 300 for generating rules based on a policy identifying data message flows and services that the data message flows should receive. The process 300 begins by receiving (at 310) a policy identifying a data message flow and at least one service that data messages in the data message flow should be forwarded. In some embodiments, the received policy is based on user input identifying a data message flow (e.g., using sets of criteria (n-tuples, IP addresses, ports, etc.) that define the data message flow) along with a service to provide for data message flow. In some embodiments, the identification of the data message flow includes a priority associated with the data message flow. The priority of the data message flow reflects a quality-of-service requirement for the data message flows in some embodiments.

Based on the service to be provided to the data message flow, the process identifies (at 320) a set of service nodes that provide the required service. Identifying the set of service nodes that provide the service includes, in some embodiments, using universally unique identifiers (UUID) for the service nodes. In some embodiments, a single UUID is used for a high-availability cluster. In some embodiments, a set of service nodes (or HA service node clusters) that all provide the required service are identified by a single UUID as well as by individual UUIDs. For data message flows that also have an associated priority, the identified set of service nodes include service nodes with a corresponding assigned priority.

Process 300 then generates (at 330) a set of rules using identifiers of the data message flow and the UUID associated with the set of identified service nodes. In some embodiments, the generated rule is a policy-based routing rule such as: Src IP{IP1}; Dest IP{IP2}; Src port{Port1}; Dest port{Port2}→UUID1 (Service A, high priority), or Src IP{1.1.1.1/24} Dest IP{2.2.2.2/24}; Src port{Port3}; Dest port{Port4}→UUID2 (Service B). In some embodiments, the UUID (e.g., UUID1 or UUID2) used in the generated rule identifies a set of service nodes that each have a separate UUID and are selected from in the processing of data messages.

After generating (at 330) the set of rules, a set of tables (e.g., policy tables, or entries in previously generated tables) is generated (at 340) that is used to identify a next hop (i.e., a particular service node) to provide the service to a data message flow that falls into the definition provided in the generated rule. In some embodiments, the set of tables includes a first table that identifies the individual service nodes (e.g., by their UUIDs) associated with a UUID for the identified set of service nodes (e.g., all service nodes providing the service or all service nodes providing the service with the correct priority) and a second table that identifies IP addresses for a service node selected from the first table. The first table may not have an entry for the generated rule in cases where the UUID identifies a single service node and the second table identifies an IP address for the UUID identifying the single service node. In some embodiments, the first table implements a load balancing operation based on the computed scores. One of ordinary skill in the art will understand that there are other methods of implementing load balancing among the service nodes identified by the generated rules.

The process 300 then provides (at 350) the rules and sets of tables generated (at 330 and 340) to the device that directs data messages to the service nodes as configuration data and the process ends. One of ordinary skill in the art will appreciate that the set of rules and tables generated in the process 300 may be configuration (e.g., management plane) data for installing the rules and tables in a data plane of the device. One of ordinary skill in the art will also appreciate that the rules and tables described above are just one example of how a data plane could be programmed to implement the policies and methods described throughout this application. In some embodiments, operations 320-350 are performed for each active policy after updated attribute data sets are received as described above in relation to FIG. 2.

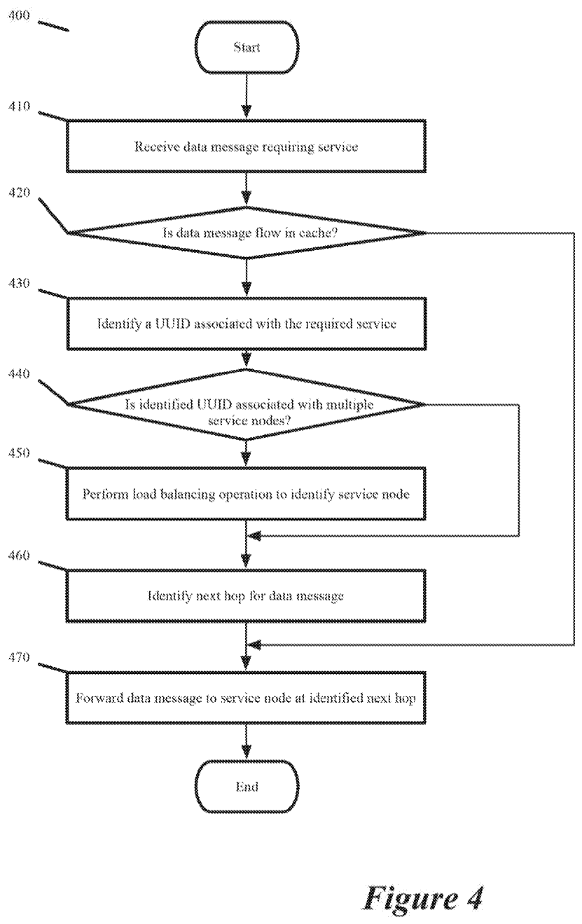

FIG. 4 conceptually illustrates a process 400 for processing data messages at a device configured with the rules and tables generated in the process 300. In some embodiments, the process 400 is performed by a device at which bump-in-the-wire services (i.e., services that do not change the layer 2 addresses of processed data messages) are provided (e.g., a gateway device, an edge router). In other embodiments, the process 400 is performed by a device at which layer 3 services or a combination of layer 2 and layer 3 services are provided. The process 400 begins by receiving (at 410) a data message destined for a machine (e.g., a virtual machine, container, namespace) reached through the device that requires a service provided by a set or service nodes.

A cache is then consulted to determine (at 420) whether the data message flow associated with the received data message has previously been assigned a service node to provide the service. If the process 400 determines (at 420) that the cache contains an entry for the data message flow, the process forwards the data message to the service node identified in the cache. If the process 400 determines (at 420) that the data message flow associated with the data message is not in the cache, the process 400 identifies (at 430) a UUID associated with the required service. In some embodiments, the UUID is identified using a policy-based routing rule as described above. A policy-based routing rule, in some embodiments, is defined to apply to data message flows with header field values that fall within a range of header field values (e.g., an IP subnet such as 1.1.1.0/24) so that multiple data message flows match a same rule.

The process 400 then determines (at 440) whether the identified UUID is associated with multiple service nodes. In some embodiments, the determination is based on whether the identified UUID exists in a first examined table that includes UUIDs for which to provide a selection operation (e.g., a load balancing operation). If the process determines (at 440) that the UUID is associated with multiple service nodes, the process performs (at 450) a load balancing operation to select a particular service node to provide the service for the data message flow to which the received data message belongs. The load balancing operation, in some embodiments, is based on the computed score (as described above in relation to FIG. 2). The selected service node, in some embodiments, is identified by a UUID that is specific to the selected service node.

After the UUID for a selected service node is identified (through the load balancing operation) or if the process 400 determines (at 440) that the identified UUID is not associated with multiple service nodes, the identified UUID is used to identify (at 460) a next hop (e.g., an IP address of the interface to the service node) to which to forward the data message. In some embodiments, this identification is based on a table that maps UUIDs to interfaces (e.g., IP addresses of interfaces connected to the identified service node) as described above in relation to FIG. 3. After identifying the interface of the identified service node, the data message is forwarded (at 470) to the service node through the interface and the process ends. In some embodiments, upon selecting a service node for a first data message in a data message flow, the service node is associated with the data message flow in the cache examined as part of operation 420.

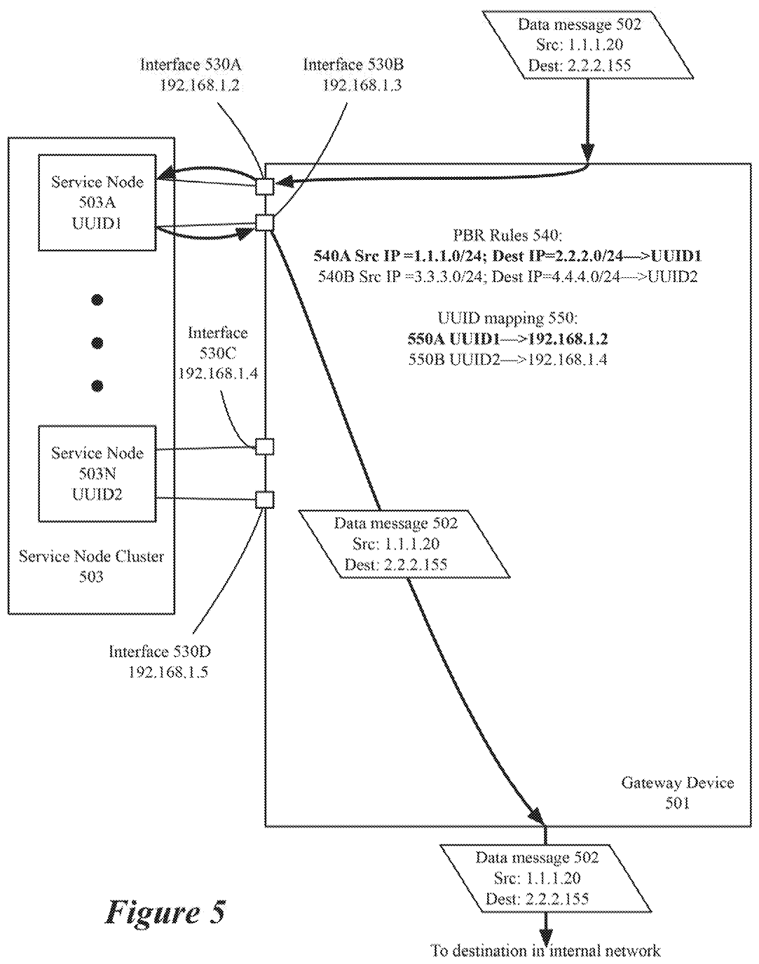

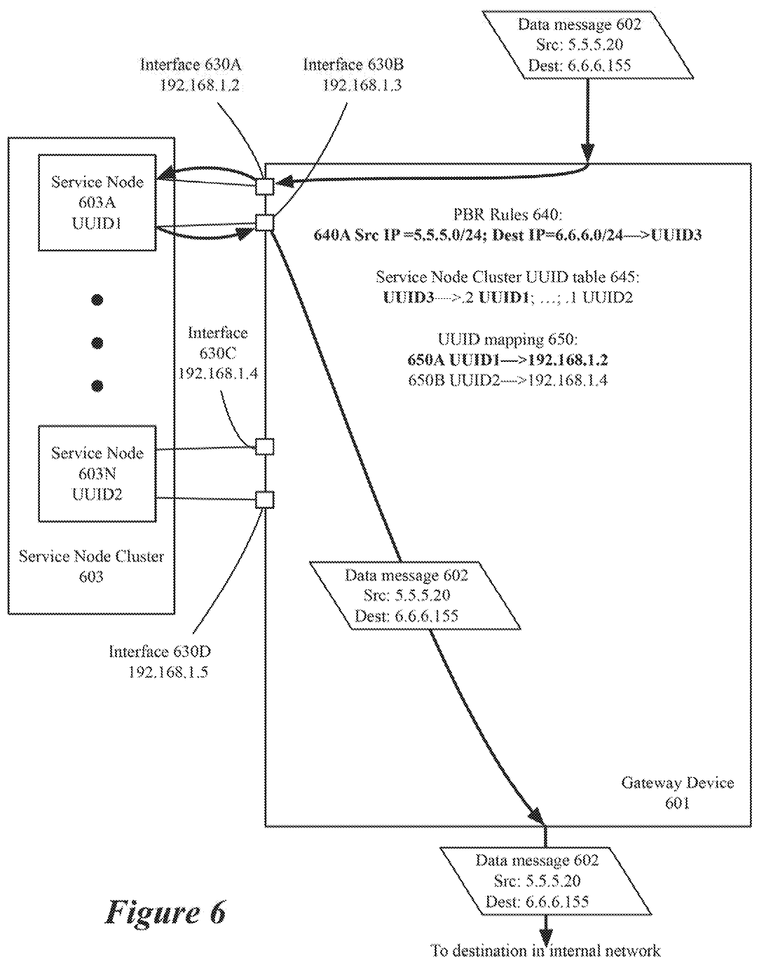

FIGS. 5 and 6 illustrate an embodiment in which a gateway device provides services to data messages traversing the gateway device according to process 400. FIG. 5 illustrates a data message that hits a policy-based routing rule that identifies a single service node to provide the service required by the data message. FIG. 5 illustrates a gateway device 501 with interfaces 530A-D to service nodes 503A and 503N in service node cluster 503. As described in relation to FIG. 4, data message 502 is received at an uplink (i.e., a connection to an external network) of gateway device 501 and is compared to entries in a cache (not shown) and no entry corresponding to the data message is found. The gateway device then examines its policy-based routing rules 540 and finds a matching rule 540A that identifies a UUID (i.e., UUID1) associated with a service node for providing the service to the data message. In some embodiments, the identified service node is specified in the PBR rule 540A because it was identified as matching a priority indicated for the data message flows matching the criteria specified in PBR rule 540A. Once the service node is selected for the data message, some embodiments create an entry in a cache to ensure that the same service node processes all data messages in a single data message flow.

Using the identified UUID (i.e., UUID1) and a UUID mapping table 550 an interface 530A having IP address 192.168.1.2 is identified as the next hop for the data message by entry 550A. In some embodiments, the destination MAC address is the MAC address of the interface 530B and is unchanged by the service node (i.e., the service node is a bump-in-the-wire service node). While in other embodiments the destination MAC address is for an interface of a service node that provides a layer 3 service. After processing by the service node 503A, the data message is returned to the gateway device 501 which then identifies the next hop for the data message which in the illustrated example is a downlink interface of the gateway device that connects to the internal network (not shown). The data message as shown has the same source and destination IP addresses as when it entered on the uplink, but one of ordinary skill in the art will appreciate that some data messages will have network address translation applied to change the source address, destination address, or both. In other embodiments (or for other data messages), another service node to provide a next service in a service chain is identified as the next hop by a different policy-based routing rule.

FIG. 6 illustrates a data message that hits a policy-based routing rule that identifies a UUID associated with a set of service nodes to provide the service required by the data message. FIG. 6 illustrates a gateway device 601 with interfaces 630A-D to service nodes 603A and 603N in service node cluster 603. As described in relation to FIG. 4, data message 602 is received at an uplink (i.e., a connection to an external network) of gateway device 601 and is compared to entries in a cache (not shown) and no entry corresponding to the data message is found. The gateway device then examines its policy-based routing rules 640 and finds a matching rule 640A that identifies a UUID (i.e., UUID3) associated with a set of service nodes for providing the service to the data message. In some embodiments, the identified set of service nodes is specified in the PBR rule 640A because the specification of the rule does not provide a priority and therefore all the service nodes providing a specified service are candidates for providing the service. In other embodiments, a set of service nodes is specified in the PBR rule 640A because the set of service nodes all have a same priority as the priority specified for the data message flows identified by the PBR rule.

After identifying the UUID (i.e., UUID3) for the set of service nodes, a service node cluster UUID table 645 is examined to see if the UUID corresponds to a group of load balanced service nodes. In the illustrated embodiment the UUID (i.e., UUID3) corresponds to the service node cluster 603 including service node 603A-N. In the service node cluster UUID table 645, each service node in service node cluster 603 is assigned a weight based on the computed scores and, based on the weights and a load balancing method, a particular service node (identified by its UUID (i.e., UUID1)) is selected to provide the service for the data message flow. Once the service node is selected for the data message, some embodiments create an entry in a cache to ensure that the same service node processes all data messages in a single data message flow.

Using the identified UUID (e.g., UUID1) and a UUID mapping table an interface 630A having IP address 192.168.1.2 is identified as the next hop for the data message. In some embodiments, the destination MAC address is the MAC address of the interface 630B and is unchanged by the service node (i.e., the service node is a bump-in-the-wire service node). While in other embodiments the destination MAC address is for an interface of a service node that provides a layer 3 service. After processing by the service node 603A, the data message is returned to the gateway device 601 which then identifies the next hop for the data message which in the illustrated example is a downlink interface of the gateway device that connects to the internal network (not shown). In other embodiments (or for other data message flows), another service node to provide a next service in a service chain is identified as the next hop by a different policy-based routing rule.

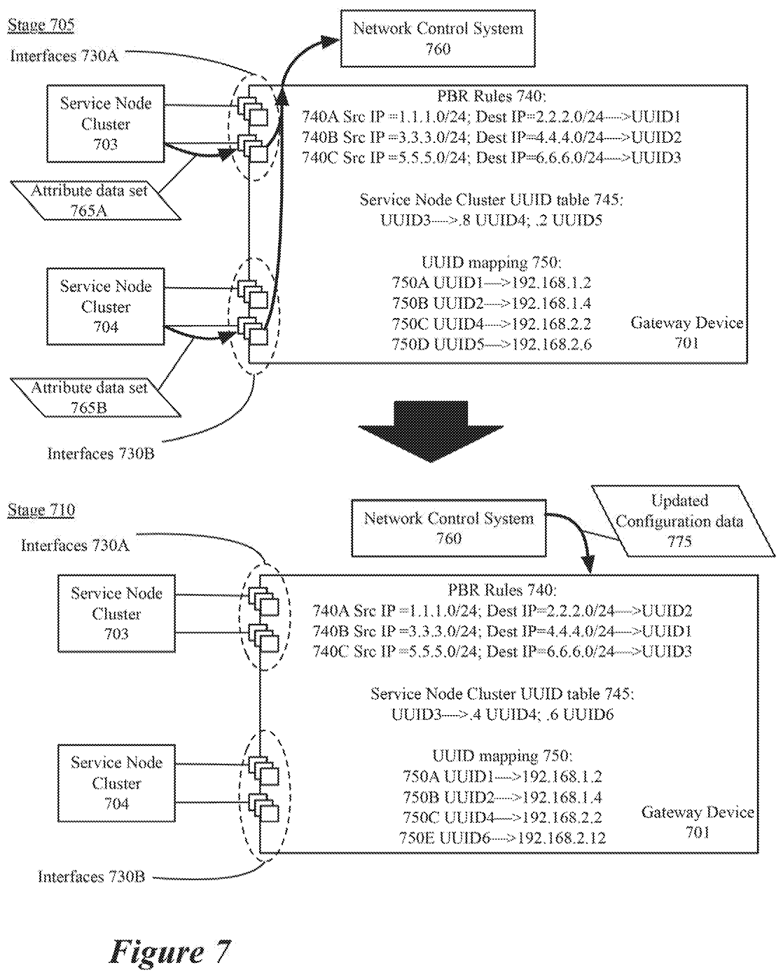

As shown in FIGS. 5 and 6, a gateway device (e.g., 501 and 601) includes a set of policy-based routing rules (e.g., 540/640) that identify an individual service node or a set of service nodes (e.g., using a UUID) and a set of tables (i.e., 550, 645, and 650) to identify an interface to which to forward a data message using an identified service node. FIG. 7 illustrates a gateway device 701 that has been configured to provide at least two services (i.e., provided by service node clusters 703 and 704) having its rules and tables updated based on new attribute data sets. Each service node cluster is associated with a different set of UUIDs (i.e., service node cluster 703 is associated with UUID1 and UUID2 and service node cluster 704 is associated with UUIDs 3-6). Additionally, each service node cluster is accessed through a different set of interfaces (e.g., interfaces 730A and 730B) At stage 705, the service nodes of the service node clusters report current attribute data sets 765A and 765B. The attribute data sets 765, in some embodiments, include any or all of usage statistics, characteristics of the service nodes, and characteristics of the connections to the service nodes.

Usage statistics include any or all of a current flow load (e.g., number of active flows currently handled by the service node), a number of dropped packets, a current CPU load (e.g., a percent of CPU processing power available), round trip time (e.g., determined by sending a dummy packet or by receiving information from service node regarding CPU and multithreading capacity), and additional usage statistics as relevant. Characteristics of the service nodes, and characteristics of the connections to the service nodes include any or all of CPU capacity, packet per second capacity, whether the service node is executing on a same host computer as the edge device, the bandwidth of the connection between the service node and the edge device. In some embodiments using HA clusters of service nodes, the attribute data set reflects only the attributes associated with the active service node.

The attribute data sets 765 are forwarded to network control system 760 for network control system 760 to compute updated scores for each service node according to operations 220-250 of process 200. In FIG. 7, the attribute set 765B also includes attributes for a newly added service node (associated with “UUID6”) and an indication that a previously available service node (associated with “UUID5”) is no longer available. The network control system then performs operations 320 to 350 of process 300 for each policy that identifies a data message flow that requires a specific service (and a priority associated with the service) to provide updated rules and tables to gateway device 701. At stage 705, three policy-based routing rules 740A-C are configured for three different data message flow groups (flows from a source IP address in the 1.1.1.0/24 subnet to destination in a 2.2.2.0/24 subnet, flows from a source IP address in the 3.3.3.0/24 subnet to destination in a 4.4.4.0/24 subnet, and flows from a source IP address in the 5.5.5.0/24 subnet to destination in a 6.6.6.0/24 subnet). In some embodiments, the rules include additional criteria that are based on values in other header fields of data messages such as source and destination ports, etc. Rules 740 identify service nodes in service node cluster 703 with rule 740A identifying a service node assigned a high priority and rule 740B identifying a service node with a medium priority. Rule 740C identifies (i.e., using UUID 3) a service node group for providing a service with a high priority that includes service nodes in service node cluster 704 with weights 0.8 and 0.2 for load balancing between service nodes with UUIDs 4 and 5 respectively.

At stage 710, the network control system 760 has performed the operations of processes 200 and 300 to provide updated rules and tables and provides gateway device 701 with updated configuration data 775. Updated configuration data 775 updates the rules 740 and tables 745 and 750 to reflect the most recent attribute data sets. As shown in FIG. 7, service nodes associated with UUID1 and UUID2 have switched priorities such that UUID2 is now associated with rule 740A and UUID1 is now associated with rules 740B. In other embodiments, the service nodes may retain their same priority but the policies may have changed to specify a different priority for data message flows matching the criteria specified in the policy. Rule 740C still identifies a group of service nodes using UUID3, but the group of service nodes and their relative weights have changed based on the updated attribute data sets. Specifically, UUID3 is now associated with service nodes having UUID4 and UUID 6 (instead of UUID4 and UUID5) and the weight of the service node associated with UUID4 is updated to 0.4 from 0.8 to reflect that the new service node associated with UUID6 has more relative capacity (than the service node associated with UUID5) based on the updated attribute data set 765B. The updated table 750 has had the entry for UUID5 removed and includes a new entry for UUID6 that identifies an interface with IP address 192.168.2.12 as the next hop.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

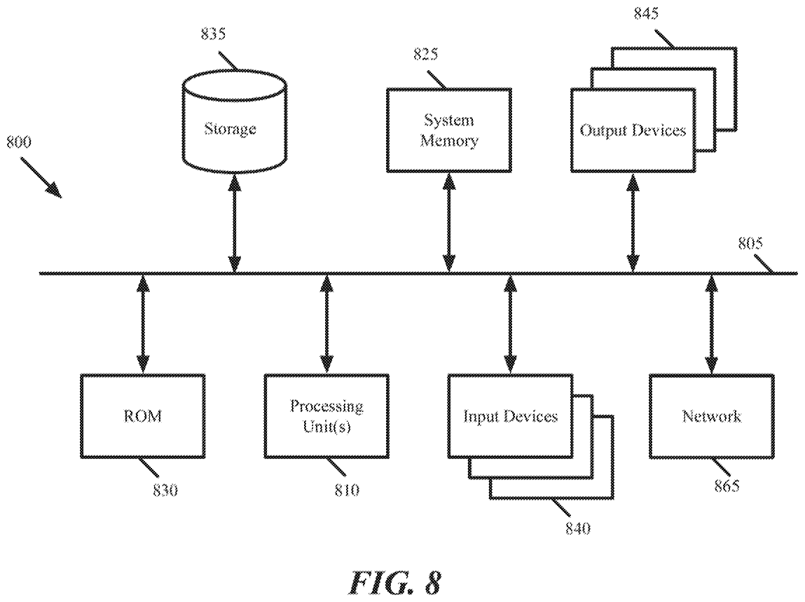

FIG. 8 conceptually illustrates a computer system 800 with which some embodiments of the invention are implemented. The computer system 800 can be used to implement any of the above-described hosts, controllers, and managers. As such, it can be used to execute any of the above described processes. This computer system includes various types of non-transitory machine readable media and interfaces for various other types of machine readable media. Computer system 800 includes a bus 805, processing unit(s) 810, a system memory 825, a read-only memory 830, a permanent storage device 835, input devices 840, and output devices 845.

The bus 805 collectively represents all system, peripheral, and chipset buses that communicatively connect the numerous internal devices of the computer system 800. For instance, the bus 805 communicatively connects the processing unit(s) 810 with the read-only memory 830, the system memory 825, and the permanent storage device 835.

From these various memory units, the processing unit(s) 810 retrieve instructions to execute, and data to process, in order to execute the processes of the invention. The processing unit(s) may be a single processor or a multi-core processor in different embodiments. The read-only-memory (ROM) 830 stores static data and instructions that are needed by the processing unit(s) 810 and other modules of the computer system. The permanent storage device 835, on the other hand, is a read-and-write memory device. This device is a non-volatile memory unit that stores instructions and data even when the computer system 800 is off. Some embodiments of the invention use a mass-storage device (such as a magnetic or optical disk and its corresponding disk drive) as the permanent storage device 835.

Other embodiments use a removable storage device (such as a floppy disk, flash drive, etc.) as the permanent storage device Like the permanent storage device 835, the system memory 825 is a read-and-write memory device. However, unlike storage device 835, the system memory is a volatile read-and-write memory, such as random-access memory. The system memory stores some of the instructions and data that the processor needs at runtime. In some embodiments, the invention's processes are stored in the system memory 825, the permanent storage device 835, and/or the read-only memory 830. From these various memory units, the processing unit(s) 810 retrieve instructions to execute, and data to process, in order to execute the processes of some embodiments.

The bus 805 also connects to the input and output devices 840 and 845. The input devices enable the user to communicate information and select commands to the computer system. The input devices 840 include alphanumeric keyboards and pointing devices (also called “cursor control devices”). The output devices 845 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 8, bus 805 also couples computer system 800 to a network 865 through a network adapter (not shown). In this manner, the computer can be a part of a network of computers (such as a local area network (“LAN”), a wide area network (“WAN”), an Intranet, or a network of networks, such as the Internet. Any or all components of computer system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, several figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. A method of distributing data message flows among a plurality of service nodes, the method comprising:
from each service node in the plurality of service nodes, collecting a set of attributes for the service node;
based on the collected set of attributes, computing a score for each service node in the plurality of service nodes; and
based on the computed scores for the service nodes, distributing data message flows to the service nodes.

2. The method of claim 1, wherein the computed scores for each service node are weight values, wherein the weight values specify a distribution of data message flows to the different service nodes.

3. The method of claim 2 wherein the weight values are used to determine a percent of the data message flows that are directed to each service node.

4. The method of claim 1, wherein
the scores for each service are priority levels,
each data message in a set of data message flows is associated with a priority level, and
the set of data messages is distributed to the service nodes based on the priority levels of the service nodes and the data messages.

5. The method of claim 4, wherein distributing data message flows to the service nodes comprises selecting, for a particular data message flow, a particular service node using a policy-based routing rule that specifies a service node identifier for the data message flow.

6. The method of claim 5, wherein the service node identifier is a service node group identifier that is used to identify a group of service nodes with a priority that matches the priority level associated with data messages to which the policy-based rule applies.

7. The method of claim 6, wherein the service node group comprises the particular service node, and the particular service node is selected from the group of service nodes.

8. The method of claim 5, wherein the policy-based routing rule specifies an identifier for the particular service node.

9. The method of claim 1, wherein the service nodes provide an edge service.

10. The method of claim 1, wherein the set of attributes comprise at least one attribute of the service node and a usage attribute.

11. The method of claim 1 further comprising:
from each service node in the plurality of service nodes, collecting a set of updated attributes for the service node;
based on the set of updated attributes, computing an updated score for each service node in the plurality of service nodes; and
based on the computed updated scores for the service nodes, distributing data message flows to the service nodes.

12. A non-transitory machine readable medium storing a program for execution by a set of processing units, the program for distributing data message flows among a plurality of service nodes associated with at least two different levels of priority, the program comprising sets of instructions for:
from each service node in the plurality of service nodes, collecting a set of attributes for the service node;
based on the collected set of attributes, computing a priority level for each service node in the plurality of service nodes; and
based on the computed priority levels for the service nodes and priority levels associated with data message flows, distributing data message flows to the service nodes.

13. The non-transitory machine readable medium of claim 12, wherein the set of instructions for distributing data message flows to the service nodes comprises a set of instructions for selecting, for a particular data message flow, a particular service node using a policy-based routing rule that specifies a service node identifier for the data message flow.

14. The non-transitory machine readable medium of claim 13, wherein the service node identifier is a service node group identifier that is used to identify a group of service nodes with a priority that matches the priority level associated with data messages to which the policy-based rule applies.

15. The non-transitory machine readable medium of claim 14, wherein the service node group comprises the particular service node, and the particular service node is selected from the group of service nodes.

16. The non-transitory machine readable medium of claim 15, wherein the policy-based routing rule specifies an identifier for the particular service node.

17. The non-transitory machine readable medium of claim 12, wherein the set of attributes comprise at least one attribute of the service node and a usage attribute.

18. The non-transitory machine readable medium of claim 12 further comprising sets of instructions for:
from each service node in the plurality of service nodes, collecting a set of updated attributes for the service node;
based on the set of updated attributes, computing an updated score for each service node in the plurality of service nodes; and
based on the computed updated scores for the service nodes, distributing data message flows to the service nodes.

19. The non-transitory machine readable medium of claim 13, wherein the plurality of service nodes comprises at least one pair of service nodes in an active-standby configuration, wherein a first service node in the pair of service nodes is in an active mode of operation and a second service node in the pair of service nodes is in a standby mode of operation.

20. The non-transitory machine readable medium of claim 19 further comprising sets of instructions for:
monitoring the health of the plurality of service nodes; and
when a service node in an active mode of operation for a particular pair of service nodes fails, switching the service node in the particular pair of service nodes that is in a standby mode of operation into an active mode of operation.
